(19) United States
(12) Patent Application Publication
(10) Pub. No.: US 2025/0333283 A1
(43) Pub. Date: Oct. 30, 2025

(54) TOOL WITH INTERCHANGEABLE HEAD

(71) Applicant: Hong Ann Tool Industries Co., Ltd., Taichung City (TW)

(72) Inventor: Cheng-Wei SU, Taichung City (TW)

(21) Appl. No.: 19/037,520

(22) Filed: Jan. 27, 2025

(30) Foreign Application Priority Data
Apr. 30, 2024 (TW) 113116177

(51) Int. Cl. B66F 15/00; B25G 3/26

(52) U.S. Cl. CPC B66F 15/00; B25G 3/26

(57) ABSTRACT

A tool with an interchangeable head comprises a lever having a slot along an axis and a hole. A tool head includes an insertion part with a groove along its radial circumference. A switching mechanism comprises a sliding mechanism with a pressing part and a locking mechanism having a locking part. When the sliding mechanism is positioned in a first position, the locking part engages the tool head groove, preventing separation. In a second position, the locking part disengages, enabling tool head removal. The sliding mechanism moves along the axis between first and second positions, operatively connected to the lever. The locking mechanism, with its locking part positioned in the hole, selectively secures or releases the tool head.

### BACKGROUND OF THE INVENTION

The present invention relates to hand tools, and more particularly, to a tool with an interchangeable head mechanism that enables quick and easy head replacement without the need of additional tools.

Taiwan Patent No. M647545 discloses a hand tool that comprises a connecting rod, a sleeve with a non-circular recessed portion, and a hole passing through the sleeve wall connecting to the recessed portion. A fastener engages the hole and extends into the recessed portion. The tool also comprises a pry bar assembly with multiple pry heads of different functional shapes and connecting rods. Each rod is connected to a pry head and has an insertion end with a narrower neck portion and a groove around the neck portion. The insertion end faces the recessed portion, allowing the rod to be inserted and preventing rotation relative to the sleeve. The fastener enters the groove at the neck portion, blocking the rod.

However, the tool requires external tools for head replacement, introducing unnecessary complexity. The reliance on additional tools and complicated fastening mechanisms reduces the tool's convenience and efficiency. It also suffers from cumbersome head replacement procedures, insecure locking mechanisms, and limited versatility, hindering its effectiveness for various tasks.

The present invention is, therefore, intended to obviate or at least alleviate the problems encountered in the prior art.

### SUMMARY OF THE INVENTION

The present invention provides a tool with an interchangeable head comprising: a lever having a slot along an axis and a radial hole. A tool head with an insertable end has a groove along its radial circumference. A switching mechanism comprising a structure including a sliding mechanism and locking mechanism enables tool head replacement. When the sliding mechanism is in a first position, a locking part engages the tool head groove, preventing separation. In a second position, the locking part disengages, allowing tool head removal. The sliding mechanism moves along the axis between first and second positions, connected to the lever. The locking mechanism, with a locking part positioned in the hole, selectively secures or releases the tool head. This design provides a simple, secure method for quickly changing tool heads while maintaining structural integrity during use.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the concept upon which this disclosure is based may readily be utilized as a basis for designing other structures, methods, and systems for carrying out the several purposes of the invention. It is important, therefore, that the claims be regarded as including such equivalent constructions insofar as they do not deviate from the spirit and scope of the invention.

Furthermore, the purpose of the abstract is to enable the general public, particularly scientists, engineers, and practitioners in the field who may not be familiar with patent or legal terminology, to quickly determine the nature and essence of the technical information through a brief examination. The abstract is not meant to define the invention, which is determined by the claims, nor is it intended to limit the scope of the invention in any manner.

Other objectives, advantages, and new features of the invention will become apparent from the following detailed description of the invention when considered in conjunction with the accompanied drawings.

### BRIEF DESCRIPTION OF DRAWINGS

FIG. 1 is a perspective view of a tool with an interchangeable head in accordance with a first embodiment of the present invention.

FIG. 2 is an exploded perspective view of the tool with the interchangeable head of FIG. 1.

FIG. 3 is a cross-sectional view of the tool with the interchangeable head of FIG. 1.

FIG. 4 illustrates a sliding mechanism of the tool with the interchangeable head of FIG. 1 moved to a second position.

FIG. 5 is an exploded perspective view of the tool with the interchangeable head in accordance with a second embodiment of the present invention.

FIG. 6 is an exploded perspective view of the tool with the interchangeable head of FIG. 5.

FIG. 7 is a cross-sectional view of the tool with the interchangeable head of FIG. 5.

FIG. 8 is a cross-sectional view of a push button of the tool with the interchangeable head of FIG. 5.

FIG. 9 illustrates the movement of the push button.

FIG. 10 illustrates a sliding mechanism of the tool with the interchangeable head of FIG. 5 moved to a second position.

### DETAILED DESCRIPTION OF THE INVENTION

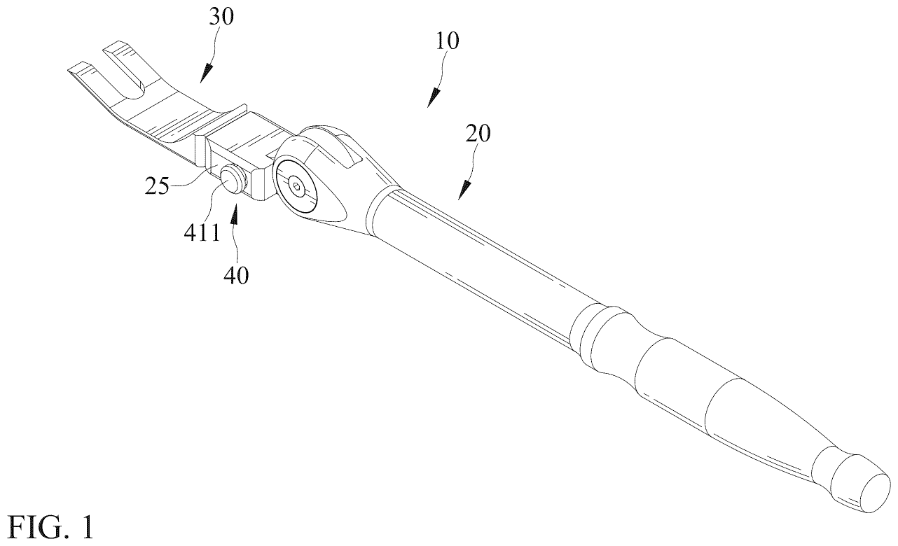

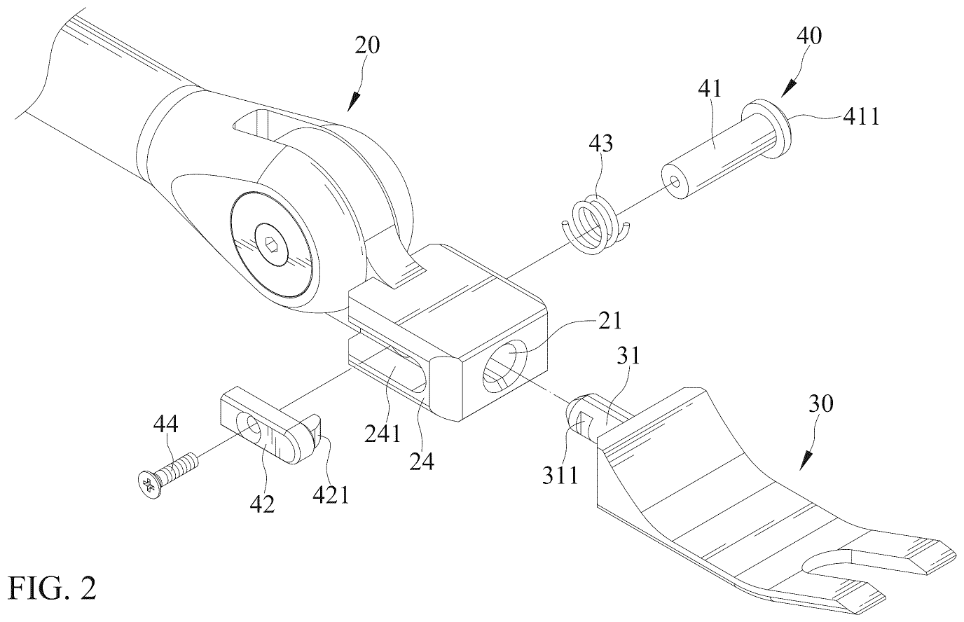

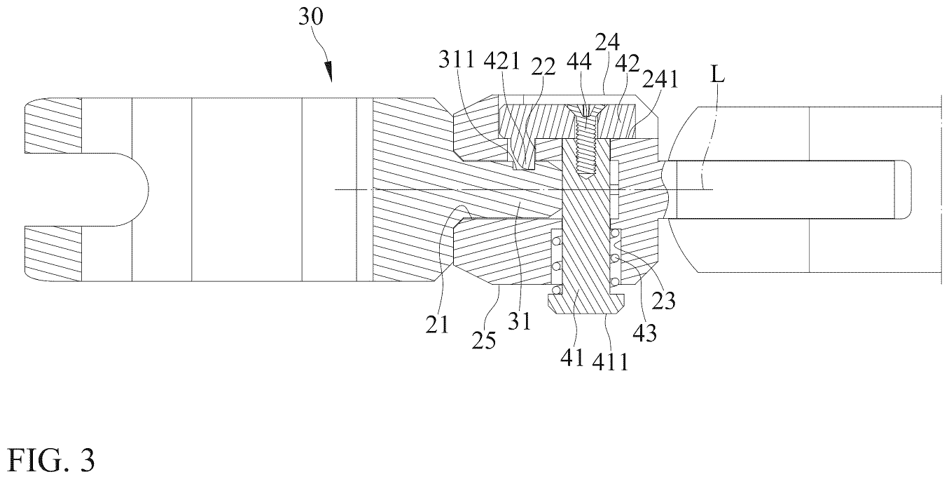

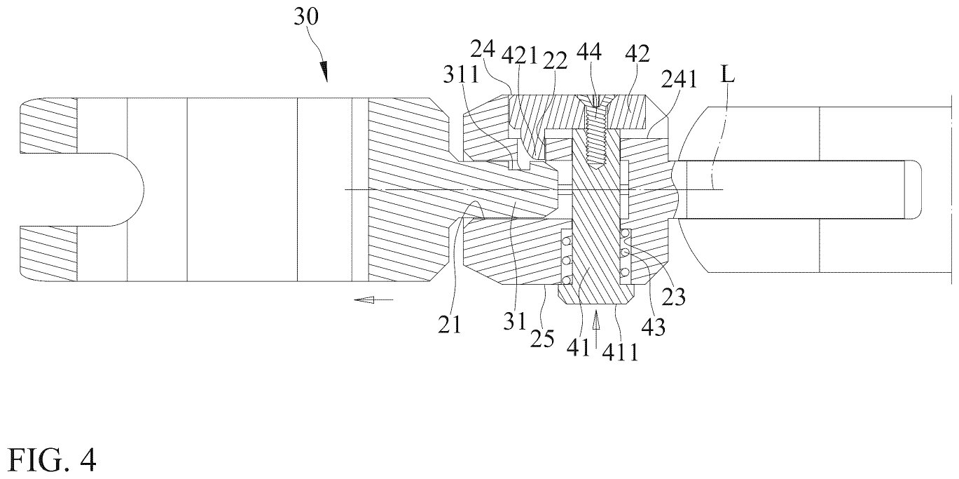

Referring to FIGS. 1-4, a tool 10 with an interchangeable head in accordance with the present invention comprises a lever 20, a tool head 30, and a switching mechanism 40.

The lever 20 has a slot 21 set along an axis L, and a hole 22 set radially on the axis L and communicating with the slot 21.

One end of the tool head 30 is provided with an insertion part 31, which can be detachably inserted into the slot 21. The outer circumferential edge of the insertion part 31 along the axis L is provided with a groove 311.

The switching mechanism 40 comprises a structure including a sliding mechanism 41 and a locking mechanism 42. In the embodiment, the sliding mechanism 41 and the locking mechanism 42 are two pieces detachably integrated, but can also formed as a single piece. The sliding mechanism 41 is slidable along the axis L between a first and a second position and is connected to the lever 20. The locking mechanism 42 is connected to the sliding mechanism 41 and has a locking part 421. The locking part 421 is set inside the hole 22. When the sliding mechanism 41 is in the first position, the locking part 421 is inserted into the groove 311, preventing the tool head 30 from separating from the slot 21. When the sliding mechanism 41 is in the second position, the locking part 421 separates from the groove 311, allowing the tool head 30 to be removed from the slot 21.

The lever 20 has a sliding groove 23 set radially along the axis L, positioned on the opposite side of the slot 21 from the tool head 30. The sliding mechanism 41 is set inside the sliding groove 23, and the locking mechanism 42 is connected to one end of the sliding mechanism 41.

The lever 20 forms a first side 24 and a second side 25 on its left and right sides along the axis L. The first side 24 has a positioning slot 241 that connects the slot 21 and the sliding groove 23. The locking mechanism 42 is set inside the positioning slot 241. The switching mechanism 40 comprises a flexible element 43, which is sleeved on the sliding mechanism 41 and positioned near the second side 25 of the slot 21. One end of the flexible element 43 abuts against the inner circumference of the sliding groove 23, and the other end pushes the sliding mechanism 41 to move towards the first position.

The switching mechanism 40 comprises a connecting element 44, which passes through the locking mechanism 42 from the side opposite the sliding mechanism 41 and is connected to the sliding mechanism 41 by a screw-lock method.

The end of the sliding mechanism 41 opposite the locking mechanism 42 is provided with a pressing part 411, which extends out of the sliding groove 23 and protrudes from the second side 25.

The tool 10 can provide a function of replacing the tool head 30 through the above structure. When the sliding mechanism 41 is in the first position, the tool 10 can fix the tool head 30 through the locking mechanism 42. When the sliding mechanism 41 is in the second position, the tool head 30 can be separated from the lever 20, allowing the user to freely replace the tool head 30, which can be in the form of a pry tool or a scraper.

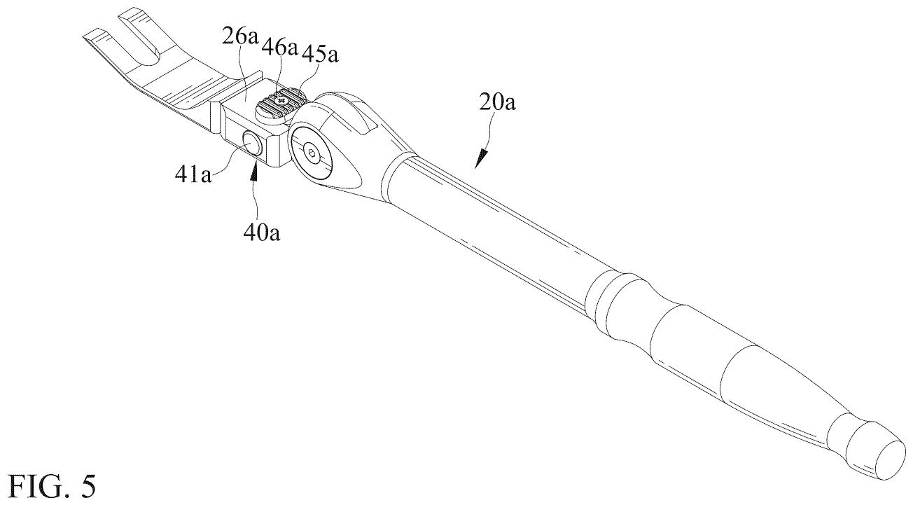

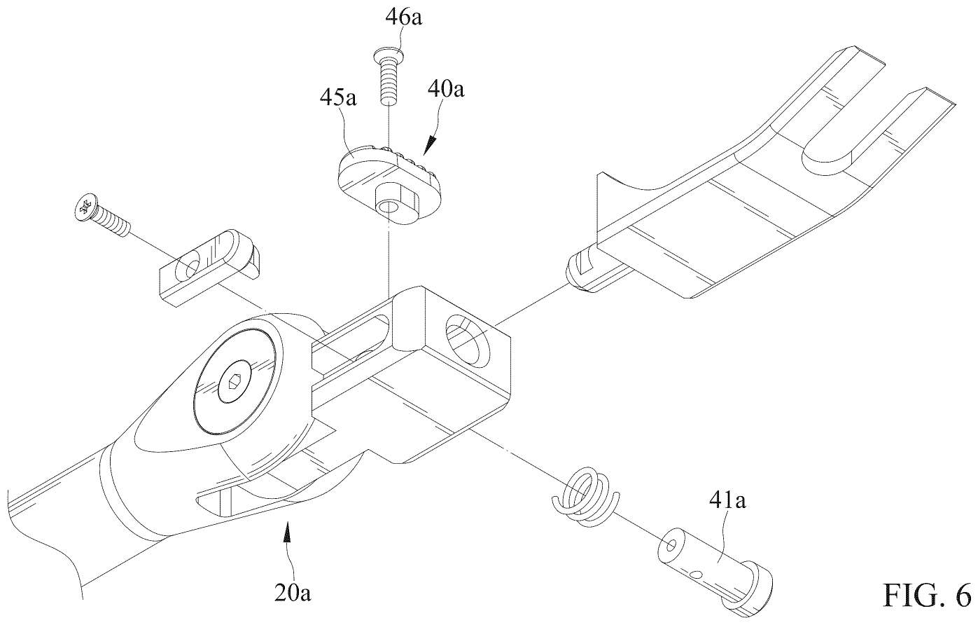

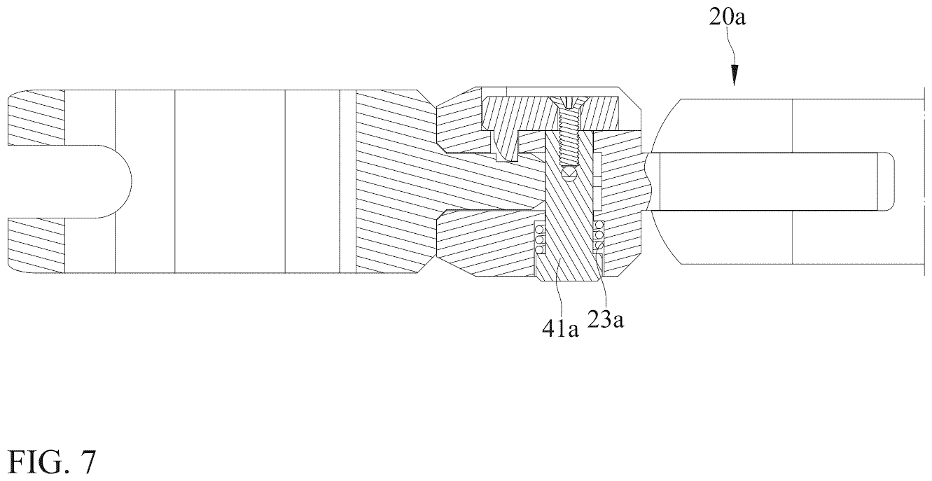

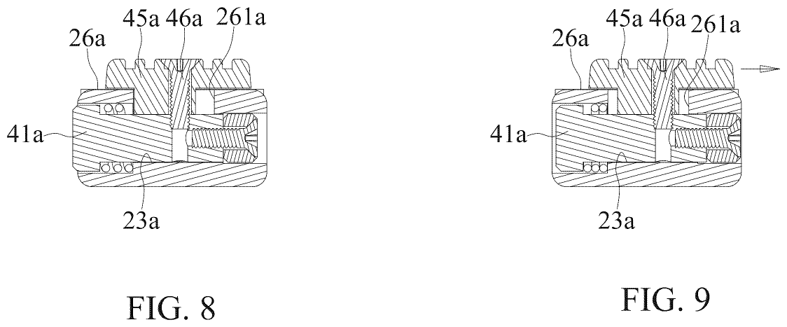

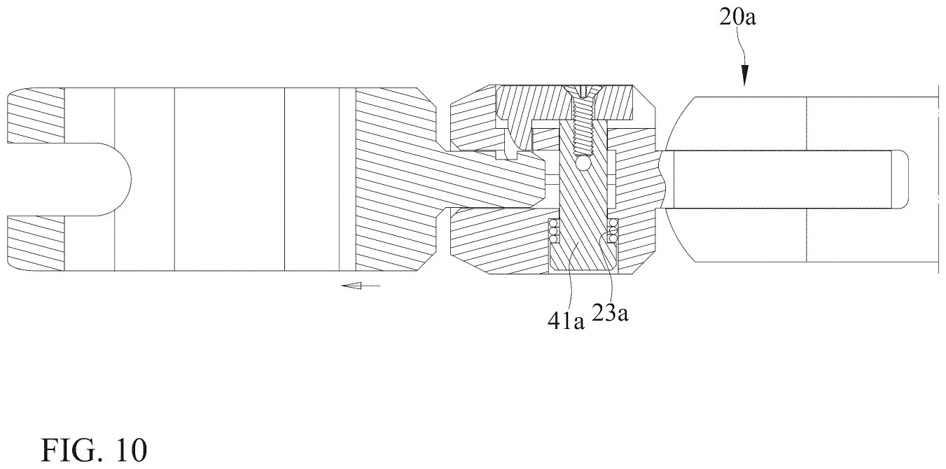

Referring to FIGS. 5-10, a tool with an interchangeable head according to a second embodiment shares many characteristics with the first embodiment. Components similar to those of the first embodiment have like reference numerals with the suffix “a”.

The second embodiment of the tool with an interchangeable tool head is largely similar to the first, with the main difference being that the lever 20a has a top part 26a along its vertical upper edge. The top part 26a has a top groove 261a extending parallel to the sliding groove 23a and communicating with it. The switching mechanism 40a includes a push button 45a, which is inserted into the top groove 261a and connected to the sliding mechanism 41a. Movement of the push button 45a can drive the sliding mechanism 41a to slide between the first and second positions.

The switching mechanism 40a includes a linkage element 46a, which passes through the push button 45a from the side opposite the sliding mechanism 41a and is connected to the sliding mechanism 41a by a screw-lock method.

In view of the foregoing, the tool 10 provides tool head replacement functionality through the above structure. When the tool head 30 is connected to the lever 20, it obtains a locking effect through the switching mechanism 40. By actuating the sliding mechanism 41 to move between its first and second positions, the tool head 30 can be detached from the lever 20. The interchangeable design of the tool heads allows users to freely select between different head positions. The mechanism eliminates the need for additional tools to switch heads, providing a simple, intuitive head replacement process that enhances operational efficiency in diverse work environments.

Although specific embodiments have been illustrated and described, numerous modifications and variations are still possible without departing from the scope of the invention. The scope of the invention is limited by the accompanying claims.

1. A tool with an interchangeable head comprising:
a lever, wherein the lever has a slot extending along an axis, wherein the lever has a hole extending radially on the axis and communicating with the slot;
a tool head, wherein a first end of the tool head has an insertion part that is detachably insertable into the slot, wherein the insertion part has a groove extending along a radial outer circumference of the axis; and
a switching mechanism, wherein the switching mechanism comprises a structure including a sliding mechanism and a locking mechanism, wherein the sliding mechanism is slidable along the axis between a first position and a second position and is connected to the lever, wherein the locking mechanism is connected to the sliding mechanism and is provided with a locking part set in the hole, wherein when the sliding mechanism is in the first position, the locking part is inserted into the groove and prevents the tool head from separating from the slot, and wherein when the sliding mechanism is in the second position, the locking part separates from the groove and allows the tool head to separate from the slot.

2. The tool with the interchangeable head as claimed in claim 1, wherein the lever has a sliding groove extending radially on the axis, wherein the sliding groove is set on a side opposite the tool head from the slot, wherein the sliding mechanism is set in the sliding groove, and wherein the locking mechanism is connected to a first end of the sliding mechanism.

3. The tool with the interchangeable head as claimed in claim 2, wherein the lever forms a first side and a second side on its left and right sides along the axis, wherein the first side has a positioning slot connecting the slot and the sliding groove, wherein the locking mechanism is set in the positioning slot, wherein the switching mechanism comprises a flexible element, wherein the flexible element is sleeved on the sliding mechanism and disposed near the second side of the slot, wherein a first end of the flexible element abuts against the inner circumference of the sliding groove, and wherein a second end of the flexible element pushes the sliding mechanism to move towards the first position.

4. The tool with the interchangeable head as claimed in claim 3, wherein the switching mechanism comprises a connecting element, and wherein the connecting element passes through the locking mechanism from a side opposite the sliding mechanism and is connected to the sliding mechanism.

5. The tool with the interchangeable head as claimed in claim 3, wherein a first end of the sliding mechanism opposite the locking mechanism is provided with a pressing part, and wherein the pressing part extends out of the sliding groove and protrudes from the second side.

6. The tool with the interchangeable head as claimed in claim 2, wherein the lever has a top part on a vertical upper edge thereof, wherein the top part has a top groove extending parallel to and communicating with the sliding groove, wherein the switching mechanism comprises a push button, and wherein the push button is inserted into the top groove and connected to the sliding mechanism such that movement of the push button drives the sliding mechanism to slide between the first and second positions.

7. The tool with the interchangeable head as claimed in claim 6, wherein the switching mechanism includes a linkage element, and wherein the linkage element passes through the push button from the side opposite the sliding mechanism and is connected to the sliding mechanism.

8. The tool with the interchangeable head as claimed in claim 1, wherein the lever forms a first side and a second side on its left and right sides along the axis, wherein the first side has a positioning slot connecting the slot and the sliding groove, wherein the locking mechanism is set in the positioning slot, wherein the switching mechanism comprises a flexible element, wherein the flexible element is sleeved on the sliding mechanism and disposed near the second side of the slot, wherein a first end of the flexible element abuts against the inner circumference of the sliding groove, and wherein a second end of the flexible member pushes the sliding mechanism to move towards the first position.

9. The tool with the interchangeable head as claimed in claim 1, wherein the switching mechanism comprises a connecting element, and wherein the connecting element passes through the locking mechanism from a side opposite the sliding mechanism and is connected to the sliding mechanism.

10. The tool with the interchangeable head as claimed in claim 2, wherein the switching mechanism comprises a connecting element, and wherein the connecting element passes through the locking mechanism from a side opposite the sliding mechanism and is connected to the sliding mechanism.

11. The tool with the interchangeable head as claimed in claim 4, wherein a first end of the sliding mechanism opposite the locking mechanism is provided with a pressing part, and wherein the pressing part extends out of the sliding groove and protrudes from the second side.
